(19) United States
(12) Patent Application Publication
(10) Pub. No.: US 2021/0118078 A1
(43) Pub. Date: Apr. 22, 2021

(54) SYSTEMS AND METHODS FOR DETERMINING POTENTIAL MALICIOUS EVENT

(71) Applicant: BEIJING DIDI INFINITY TECHNOLOGY AND DEVELOPMENT CO., LTD., Beijing (CN)

(72) Inventors: Xin WANG, Tianjin (CN); Pengcheng FENG, Tianjin (CN); Xiaotang LI, Beijing (CN); Wenshi ZHAN, Beijing (CN); Shaofei ZHANG, Beijing (CN); Yue JIANG, Beijing (CN)

(73) Assignee: BEIJING DIDI INFINITY TECHNOLOGY AND DEVELOPMENT CO., LTD., Beijing (CN)

(21) Appl. No.: 17/117,072

(22) Filed: Dec. 9, 2020

Related U.S. Application Data
(63) Continuation of application No. PCT/CN2018/121625, filed on Dec. 17, 2018.

(30) Foreign Application Priority Data
Jun. 21, 2018 (CN) 201810641599.5

(51) Int. Cl. G06Q 50/26; G06Q 50/30; G07C 5/06; G06N 7/00

(52) U.S. Cl. CPC G06Q 50/265; G06N 7/005; G07C 5/06; G06Q 50/30

(57) ABSTRACT

The present disclosure relates to systems and methods for determining a potential malicious event. The systems and methods may obtain real-time information related to a vehicle. The systems and methods may determine a probability of arising malicious event based on the real-time information of the vehicle. The systems and methods may determine whether the probability of arising malicious event exceeds a probability threshold. The systems and methods may in response to a determination that the probability of arising malicious event exceeds the probability threshold, determine that a potential malicious event exists.

### CROSS-REFERENCE TO RELATED APPLICATIONS

This application is a Continuation of International Application No. PCT/CN2018/121625, filed on Dec. 17, 2018, which claims priority to Chinese Application No. 201810641599. 5, filed on Jun. 21, 2018, the entire contents of which are hereby incorporated by reference in its entirety.

### TECHNICAL FIELD

The present disclosure generally relates to vehicle security techniques, and in particular, systems and methods for determining a potential malicious event inside a vehicle.

### BACKGROUND

Taxi service provides convenience for people in transportation. In general, a driver and a passenger do not know each other. Even in the online-to-offline (O2O) taxi service, the background of the driver and/or the passenger is barely known to each other. The only information that may be available to the driver and the passenger is the profile information when the driver and the passenger register the online-to-offline taxi service. It is difficult for the driver/passenger to distinguish whether the passenger/driver has intention of robbery or even threatening another people's life. During the transportation of the passenger, a malicious event (e.g., quarrel, fight, robbery, sexual harassment, etc.) may occur inside the vehicle. Conventional taxi service has no efficient way to detect the occurrence of the malicious events inside the vehicle and to intervene while the events occur. Therefore, it is desirable to provide systems and methods for determining a potential malicious event inside the vehicle, and performing interventions to protect both the driver and/or the passenger.

### SUMMARY

In one aspect of the present disclosure, a system for determining a potential malicious event in a vehicle is provided. The system may include at least one storage device, at least one processor in communication with the at least one storage device, and a communication platform connected to a network. The at least one storage device may include a set of instructions. When executing the set of instructions, the at least one processor may be configured to cause the system to obtain real-time information related to a vehicle. The at least one processor may also be configured to cause the system to determine a probability of arising malicious event based on the real-time information of the vehicle, and determine whether the probability of arising malicious event exceeds a probability threshold. In response to a determination that the probability of arising malicious event exceeds the probability threshold, the at least one processor may also be configured to cause the system to determine that a potential malicious event exists.

In some embodiments, the real-time information related to the vehicle may include at least one of an actual driving trajectory of the vehicle, a current location of the vehicle, sound information inside the vehicle, video information inside the vehicle, or profile information of a driver or a passenger inside the vehicle.

In some embodiments, determining a probability of arising malicious event may be based on at least one of: a degree of deviation between the actual driving trajectory and a predetermined driving trajectory; a desolate degree of the current location; a variation of the current location within a preset time length; at least one of a sound volume or one or more keywords from the sound information; at least one of one or more malicious behaviors or one or more malicious objects from the video information; or whether the profile information of the driver or the passenger is consistent with a registered profile information of the driver or the passenger.

In some embodiments, the real-time information related to the vehicle may include a current time, and determining a probability of arising malicious events may be further based on whether the current time is within a preset time period.

In some embodiments, the at least one processor may be further configured to cause the system to obtain order information related to the vehicle, and determine the probability of arising malicious event based on the order information and the real-time information. The order information may include order time, a departure location and a destination of the order, an order behavior of the passenger related to the vehicle.

In some embodiments, to determine a probability of arising malicious event, the at least one processor may be further configured to cause the system to obtain a trained probability determination model; and determine the probability of arising malicious event based on the real-time information and the trained probability determination model.

In some embodiments, the trained probability determination model may be generated by training a preliminary model based on one or more historical malicious events.

In some embodiments, the at least one processor may be further configured to cause the system to, in response to a determination that the probability of arising malicious event exceeds the probability threshold, perform one or more interventions.

In some embodiments, the one or more interventions include at least one of: sending a prompt to the driver or the passenger inside the vehicle; sending a warning to the driver or the passenger inside the vehicle; calling the driver or the passenger inside the vehicle; sending help information to a person near the current location of the vehicle; or sending the help information to an executive institution.

In another aspect of the present disclosure, a method for determining a potential malicious event in a vehicle is provided. The method may be implemented on a computing device having at least one processor, at least one computer-readable storage medium, and a communication platform connected to a network. The method may include obtaining real-time information related to a vehicle. The method may also include determining a probability of arising malicious event based on the real-time information of the vehicle, and determining whether the probability of arising malicious event exceeds a probability threshold. The method may further include, in response to a determination that the probability of arising malicious event exceeds the probability threshold, determining that a potential malicious event exists.

In another aspect of the present disclosure, a non-transitory computer-readable storage medium is provided. The non-transitory computer-readable storage medium may include at least one set of instructions for determining a potential malicious event in a vehicle. When executed by at least one processor of a computing device, the at least one set of instructions may direct the at least one processor to perform acts of: obtaining real-time information related to a vehicle; determining a probability of arising malicious event based on the real-time information of the vehicle; determining whether the probability of arising malicious event exceeds a probability threshold; and in response to a determination that the probability of arising malicious event exceeds the probability threshold, determining that a potential malicious event exists.

In another aspect of the present disclosure, a system for determining a potential malicious event in a vehicle is provided. The system may include an acquisition module configured to obtain real-time information related to a vehicle; a determination module configured to determine, based on the real-time information of the vehicle, a probability of arising malicious event; the determination module also configured to determine whether the probability of arising malicious event exceeds a probability threshold; and the determination module also configured to, in response to a determination that the probability of arising malicious event exceeds the probability threshold, determine that a potential malicious event exists.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting schematic embodiments, in which like reference numerals represent similar structures throughout the several views of the drawings, and wherein:

FIG. 1 is a schematic diagram illustrating an exemplary online-to-offline (O2O) service system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIGS. 4A and 4B are block diagrams illustrating exemplary processing devices according to some embodiments of the present disclosure;

FIG. 5 is a flowchart illustrating an exemplary process for determining a potential malicious event according to some embodiments of the present disclosure; and.

FIG. 6 is a flowchart illustrating an exemplary process for determining a trained probability determination model according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily regarding an on-demand transportation service (e.g., O2O service), it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a web page, a plug-in of a browser, a client terminal, a custom system, an internal analysis system, an artificial intelligence robot, or the like, or any combination thereof.

The terms “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity, or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The terms “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

The present disclosure relates to systems and methods for determining a potential malicious event inside a vehicle. The systems and methods may obtain real-time information related to the vehicle. The real-time information may include an actual driving trajectory of the vehicle, a current location of the vehicle, sound information inside the vehicle, video information inside the vehicle, or profile information of a driver or a passenger inside the vehicle, or the like, or any combination thereof. The systems and methods may also determine a probability of arising malicious event, and determine whether the probability of arising malicious event exceeds a probability threshold. In response to a determination that the probability of arising malicious event exceeds the probability threshold, the systems and methods may determine that a potential malicious event exists, and perform one or more interventions, which may decrease the number of occurred malicious events and reduce the loss caused by the occurred malicious events.

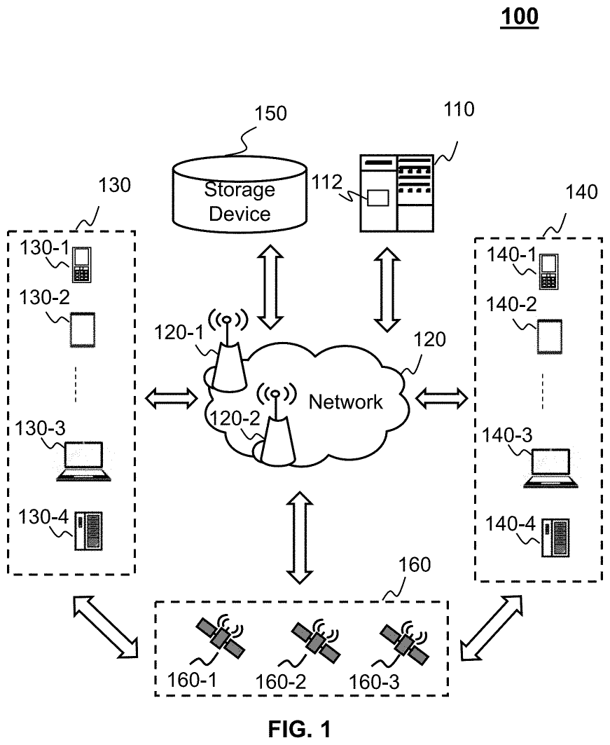

FIG. 1 is a schematic diagram illustrating an exemplary O2O service system according to some embodiments of the present disclosure. For example, the O2O service system 100 may be an online transportation service platform for transportation services. The O2O service system 100 may include a server 110, a network 120, a requester terminal 130, a provider terminal 140, a storage device 150, and a navigation system 160.

The O2O service system 100 may provide a plurality of services. Exemplary services may include a taxi hailing service, a chauffeur service, an express car service, a carpool service, a bus service, a driver hiring service, and a shuttle service. In some embodiments, the O2O service may be any online service, such as booking a meal, shopping, or the like, or any combination thereof.

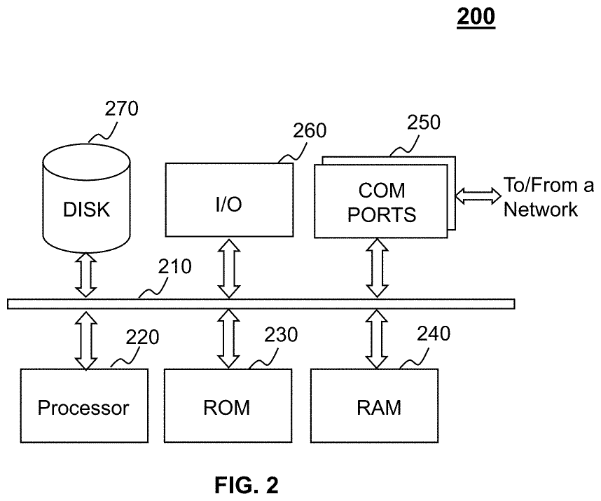

In some embodiments, the server 110 may be a single server or a server group. The server group may be centralized, or distributed (e.g., server 110 may be a distributed system). In some embodiments, the server 110 may be local or remote. For example, the server 110 may access information and/or data stored in the requester terminal 130, the provider terminal 140, and/or the storage device 150 via the network 120. As another example, the server 110 may be directly connected to the requester terminal 130, the provider terminal 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

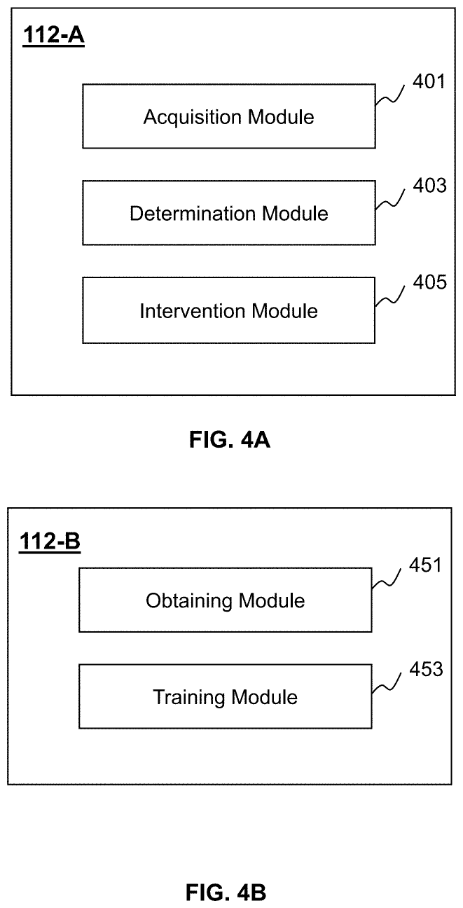

In some embodiments, the server 110 may include one or more processing devices 112 (e.g., the processing device 112-A as illustrated in FIG. 4A, the processing device 112-B as illustrated in FIG. 4B). The processing device 112 may process information and/or data relating to a vehicle to perform one or more functions described in the present disclosure. For example, the processing device 112-A may determine a probability of arising malicious event. As another example, the processing device 112-B may determine a trained probability determination model by training a preliminary model using a plurality of training samples. In some embodiments, the processing device 112 may include one or more processing devices (e.g., single-core processing device(s) or multi-core processor(s)). Merely by way of example, the processing device 112 may include one or more hardware processors, such as a central processing unit (CPU), an application-specific integrated circuit (ASIC), an application-specific instruction-set processor (ASIP), a graphics processing unit (GPU), a physics processing unit (PPU), a digital signal processor (DSP), a field-programmable gate array (FPGA), a programmable logic device (PLD), a controller, a microcontroller unit, a reduced instruction-set computer (RISC), a microprocessor, or the like, or any combination thereof.

The network 120 may facilitate the exchange of information and/or data. In some embodiments, one or more components of the O2O service system 100 (e.g., the server 110, the requester terminal 130, the provider terminal 140, the storage device 150, and the navigation system 160) may send information and/or data to other component(s) in the O2O service system 100 via the network 120. For example, the server 110 may obtain/acquire service request from the requester terminal 130 via the network 120. In some embodiments, the network 120 may be any type of wired or wireless network, or a combination thereof. Merely by way of example, the network 130 may include a cable network, a wireline network, an optical fiber network, a telecommunications network, an intranet, the Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the O2O service system 100 may be connected to the network 120 to exchange data and/or information.

In some embodiments, a requester may be a user of the requester terminal 130. In some embodiments, the user of the requester terminal 130 may be someone other than the requester. For example, a user A of the requester terminal 130 may use the requester terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requester” and “requester terminal” may be used interchangeably, and “provider” and “provider terminal” may be used interchangeably. In some embodiments, the provider terminal may be associated with one or more providers (e.g., a night-shift service provider, or a day-shift service provider).

In some embodiments, the requester terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a bracelet, footgear, glasses, a helmet, a watch, clothing, a backpack, a smart accessory, or the like, or any combination thereof. In some embodiments, the mobile device may include a mobile phone, a personal digital assistance (PDA), a gaming device, a navigation device, a point of sale (POS) device, a laptop, a desktop, or the like, or any combination thereof. In some embodiments, the virtual reality device and/or the augmented reality device may include a virtual reality helmet, a virtual reality glass, a virtual reality patch, an augmented reality helmet, augmented reality glasses, an augmented reality patch, or the like, or any combination thereof. For example, the virtual reality device and/or the augmented reality device may include a Google Glass™, a RiftCon™, a Fragments™, a Gear VR™, etc. In some embodiments, a built-in device in the motor vehicle 130-4 may include an onboard computer, an onboard television, etc. In some embodiments, the requester terminal 130 may be a device with positioning technology for locating the position of the requester and/or the requester terminal 130.

The provider terminal 140 may include a plurality of provider terminals 140-1, 140-2, . . . , 140-n. In some embodiments, the provider terminal 140 may be a device that is similar to, or the same as the requester terminal 130. In some embodiments, the provider terminal 140 may be a device utilizing positioning technology for locating the position of a user of the provider terminal 140 (e.g., a service provider) and/or the provider terminal 140. In some embodiments, the requester terminal 130 and/or the provider terminal 140 may communicate with one or more other positioning devices to determine the position of the requester, the requester terminal 130, the provider, and/or the provider terminal 140. In some embodiments, the requester terminal 130 and/or the provider terminal 140 may send positioning information to the server 110.

The storage device 150 may store data and/or instructions. In some embodiments, the storage device 150 may store data obtained from the requester terminal 130 and/or the provider terminal 140. In some embodiments, the storage device 150 may store data and/or instructions that the server 110 may execute or use to perform exemplary methods described in the present disclosure. In some embodiments, storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components of the O2O service system 100 (e.g., the server 110, the requester terminal 130, the provider terminal 140). One or more components in the O2O service system 100 may access the data or instructions stored in the storage device 150 via the network 120. In some embodiments, the storage device 150 may be directly connected to or communicate with one or more components in the O2O service system 100 (e.g., the server 110, the requester terminal 130, the provider terminal 140). In some embodiments, the storage device 150 may be part of the server 110.

The navigation system 160 may determine information associated with an object, for example, one or more of the requester terminal 130, the provider terminal 140, etc. The information may include a location, an elevation, a velocity, or an acceleration of the object, or a current time. For example, the navigation system 160 may determine a current location of the requester terminal 130. In some embodiments, the navigation system 160 may be a global positioning system (GPS), a global navigation satellite system (GLONASS), a compass navigation system (COMPASS), a BeiDou navigation satellite system, a Galileo positioning system, a quasi-zenith satellite system (QZSS), etc. The location may be in the form of coordinates, such as, latitude coordinate and longitude coordinate, etc. The navigation system 160 may include one or more satellites, for example, a satellite 160-1, a satellite 160-2, and a satellite 160-3. The satellites 160-1 through 160-3 may determine the information mentioned above independently or jointly. The navigation system 160 may send the information mentioned above to the network 120, the requester terminal 130, or the provider terminal 140 via wireless connections.

In some embodiments, one or more components of the O2O service system 100 (e.g., the server 110, the requester terminal 130, the provider terminal 140) may have permission to access the storage device 150. In some embodiments, one or more components of the O2O service system 100 may read and/or modify information relating to the requester, provider, and/or the public when one or more conditions are met. For example, the server 110 may read and/or modify one or more users' information after a service is completed. As another example, the provider terminal 140 may access information relating to the requester when receiving a service request from the requester terminal 130, but the provider terminal 140 may not modify the relevant information of the requester.

One of ordinary skill in the art would understand that when an element (or component) of the O2O service system 100 performs, the element may perform through electrical signals and/or electromagnetic signals. For example, when a requester terminal 130 transmits out a service request to the server 110, a processor of the requester terminal 130 may generate an electrical signal encoding the request. The processor of the requester terminal 130 may then transmit the electrical signal to an output port. If the requester terminal 130 communicates with the server 110 via a wired network, the output port may be physically connected to a cable, which further may transmit the electrical signal to an input port of the server 110. If the requester terminal 130 communicates with the server 110 via a wireless network, the output port of the requester terminal 130 may be one or more antennas, which convert the electrical signal to electromagnetic signal. Similarly, a provider terminal 130 may receive an instruction and/or service request from the server 110 via electrical signal or electromagnet signals. Within an electronic device, such as the requester terminal 130, the provider terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device 200 according to some embodiments of the present disclosure. In some embodiments, the server 110, the requester terminal 130, and/or the provider terminal 140 may be implemented on the computing device 200. For example, the processing device 112 of the server 110 may be implemented on the computing device 200 and configured to perform functions of the processing device 112 disclosed in this disclosure.

The computing device 200 may be a general purpose computer or a special purpose computer, both may be used to implement an O2O service system for the present disclosure. The computing device 200 may be used to implement any component of the O2O service system as described herein. For example, the processing device 112 may be implemented on the computing device, via its hardware, software program, firmware, or a combination thereof. Although only one such computer is shown, for convenience, the computer functions relating to the O2O service as described herein may be implemented in a distributed fashion on a number of similar platforms, to distribute the processing load.

The computing device 200, for example, may include a COM port 250 connected to and/or from a network connected thereto to facilitate data communications. The computing device 200 may also include a processor 220, in the form of one or more processors (or CPUs), for executing program instructions. The exemplary computing device may include an internal communication bus 210, different types of program storage units and data storage units (e.g., a disk 270, a read only memory (ROM) 230, a random access memory (RAM) 240), various data files applicable to computer processing and/or communication. The exemplary computing device may also include program instructions stored in the ROM 230, RAM 240, and/or other type of non-transitory storage medium to be executed by the processor 220. The method and/or process of the present disclosure may be implemented as the program instructions. The computer device 200 also includes an I/O device 260 that may support the input and/or output of data flows between the computing device 200 and other components. The computing device 200 may also receive programs and data via the communication network.

Merely for illustration, only one CPU and/or processor is described in the computing device 200. However, it should be noted that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

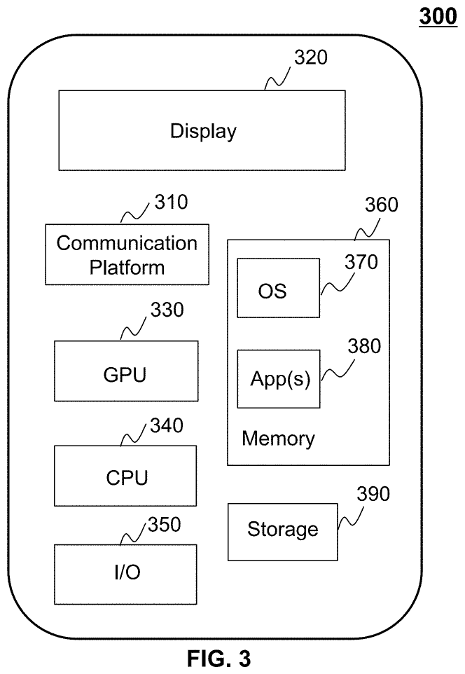

FIG. 3 is a schematic diagram illustrating exemplary hardware and/or software components of a mobile device 300 according to some embodiments of the present disclosure. In some embodiments, the mobile device 300 may be an exemplary embodiment corresponding to the requester terminal 130 or the provider terminal 140. As illustrated in FIG. 3, the mobile device 300 may include a communication platform 310, a display 320, a graphic processing unit (GPU) 330, a central processing unit (CPU) 340, an I/O 350, a memory 360, an operating system (OS) 370, a storage 390. In some embodiments, any other suitable component, including but not limited to a system bus or a controller (not shown), may also be included in the mobile device 300.

In some embodiments, an operating system 370 (e.g., iOS™, Android™′ Windows Phone™, etc.) and one or more applications 380 may be loaded into the memory 360 from the storage 390 in order to be executed by the CPU 340. The applications 380 may include a browser or any other suitable mobile apps for receiving and rendering information relating to image processing or other information from the O2O service system 100. User interactions with the information stream may be achieved via the I/O 350 and provided to the storage device 150, the server 110 and/or other components of the O2O service system 100.

To implement various modules, units, and their functionalities described in the present disclosure, computer hardware platforms may be used as the hardware platform(s) for one or more of the elements described herein. A computer with user interface elements may be used to implement a personal computer (PC) or any other type of work station or terminal device. A computer may also act as a system if appropriately programmed.

FIGS. 4A and 4B are block diagrams illustrating exemplary processing devices according to some embodiments of the present disclosure. In some embodiments, the processing device 112-A may be configured to process information and/or data to determine a probability of arising malicious event. The processing device 112-B may be configured to train a preliminary model using training samples to generate a trained model for determining a probability of arising a malicious event (also referred to as a trained probability determination model). In some embodiments, the processing device 112-A and the processing device 112-B may respectively be implemented on a computing device 200 (e.g., the processor 220) as illustrated in FIG. 2 or a CPU 340 as illustrated in FIG. 3. For example, the processing device 112-A may be implemented on a CPU 340 of a user terminal, and the processing device 112-B may be implemented on a computing device 200. Alternatively, the processing device 112-A and the processing device 112-B may be implemented on a same computing device 200 or a same CPU 340. For example, the processing device 112-A and the processing device 112-B may be implemented on a same CPU 340 of a user terminal.

The processing device 112-A may include an acquisition module 401, a determination module 403, and an intervention module 405.

The acquisition module 401 may be configured to obtain information and/or data from one or more components (e.g., the requester terminal 130, the provider terminal 140, the storage device 150, the navigation system 160) of the O2O service system 100. In some embodiments, the acquisition module 401 may obtain real-time information related to a vehicle. The real-time information may include an actual driving trajectory of the vehicle, a current location of the vehicle, sound information inside the vehicle, video information inside the vehicle, or profile information of a driver or a passenger inside the vehicle, or the like, or any combination thereof. More descriptions regarding the real-time information may be found elsewhere in the present disclosure (e.g., operation 510 of the process 500, and the relevant descriptions thereof).

The determination module 403 may be configured to determine a probability of arising malicious event. In some embodiments, the determination module 403 may determine a degree of deviation between the actual driving trajectory and a predetermined driving trajectory to generate a first result; determine a desolate degree of the current location to generate a second result; determine a variation of the current location within a preset time length to generate a third result; determine a sound volume and/or one or more keywords from the sound information to generate a fourth result; determine one or more malicious behaviors and one or more malicious objects from the video information to generate a fifth result; determine whether the profile information of the driver or the passenger is consistent with a registered profile information of the driver or the passenger to generate a sixth result, or the like. In some embodiments, the determination module 403 may also determine whether the current time is within a preset time period to determine a seventh result. The determination module 403 may determine the probability of arising malicious events based on at least one of the first result, the second result, the third result, the fourth result, the fifth result, the sixth result, or the seventh result. In some embodiments, the determination module 403 may determine whether the probability of arising malicious event exceeds a probability threshold. If the probability of arising malicious event exceeds the probability threshold, the determination module 403 may determine that a potential malicious event exists.

The intervention module 405 may be configured to perform one or more interventions. The intervention(s) may refer to measure(s) that can prevent the occurrence of a malicious event, or measure(s) that can reduce the loss (e.g., casualties, property damage) caused by an occurred malicious event. In some embodiments, the intervention(s) may include sending a prompt to a driver or a passenger inside the vehicle, sending a warning to the driver or the passenger inside the vehicle, calling the driver or the passenger inside the vehicle, sending help information to a person near the current location of the vehicle (e.g., a patrolman, a nearby driver), sending the help information to an executive institution (e.g., a police station), or the like, or any combination thereof.

The processing device 112-B may include an obtaining module 451 and a training module 453.

The obtaining module 451 may be configured to obtain information and/or data from one or more components (e.g., the server 110, the requester terminal 130, the provider terminal 140, the storage device 150, the navigation system 160) of the O2O service system 100 or from an external source via the network 120. In some embodiments, the obtaining module 451 may obtain a plurality of training samples. The plurality of training samples may include a plurality of occurred malicious events (also referred to as historical malicious events), and the real-time information corresponding to each of the plurality of occurred malicious events. Alternatively, or additionally, the obtaining module 451 may obtain a preliminary model. In some embodiments, the preliminary model may include a plurality of preliminary weights (or parameters). The preliminary weights (or parameters) may be adjusted and/or updated during the training process of the preliminary model.

The training module 453 may be configured to generate a trained probability determination model by training the preliminary model using the plurality of training samples. In some embodiments, the real-time information corresponding to an occurred malicious event may be inputted into the preliminary model to determine an actual output. The actual output may be a first value representing a malicious event, or a second value representing a not malicious event. For the real-time information corresponding to the plurality of occurred malicious events, a plurality of actual outputs may be determined. A desired output may be the first value representing a malicious event. The training module 453 may compare each of the plurality of actual outputs with the desired output to determine a loss function. During the training of the preliminary model, the training module 453 may adjust the plurality of preliminary weights (or parameters) to minimize the loss function. After the loss function is minimized, a trained probability determination model may be determined according to the adjusted weights (or parameters).

The modules in the processing devices 112-A and 112-B may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, a module of a processing device 112 (e.g., the processing device 112-A, the processing device 112-B) may be divided into two or more units. For example, the determination module 403 may be divided into two units. The first unit may be configured to determine a probability of arising malicious event, and the second unit may be configured to determine that a potential malicious event exists based on the probability of arising malicious event. In some embodiments, a processing device 112 (the processing device 112-A, and/or the processing device 112-B) may include one or more additional modules. For example, the processing device 112-A may include a storage module (not shown) configured to store data. In some embodiments, the processing device 112-A and the processing device 112-B may be integrated to a single processing device 112 to perform the functions thereof. The integrated processing device 112 may train a preliminary model using training samples to generate a trained probability determination model, and/or determine a probability of arising malicious event based on real-time information related to a vehicle and the trained probability determination model.

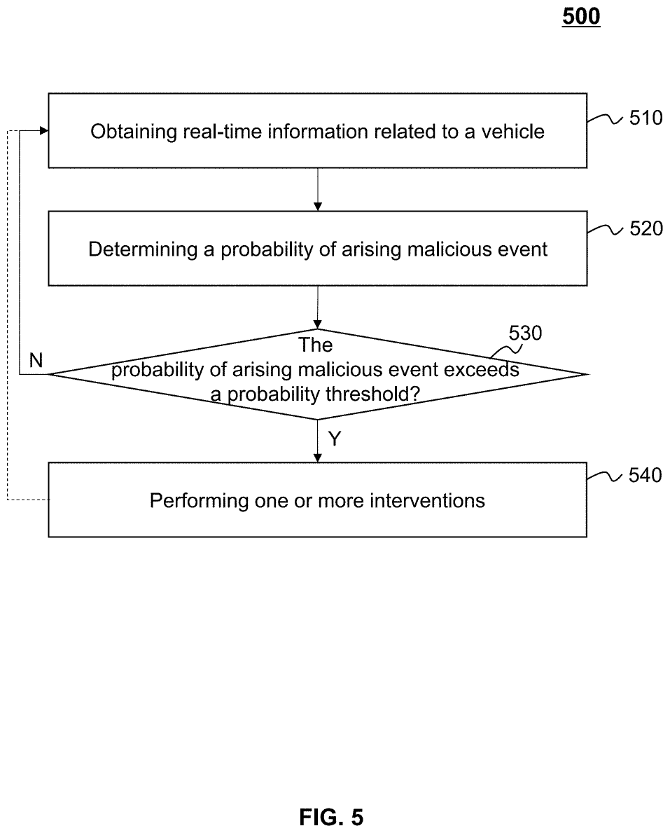

FIG. 5 is a flowchart illustrating an exemplary process for determining a potential malicious event according to some embodiments of the present disclosure. For illustration purposes only, the processing device 112-A may be described as a subject to perform the process 500. However, one of ordinary skill in the art would understand that the process 500 may also be performed by other entities. For example, one of ordinary skill in the art would understand that at least a portion of process 500 may be implemented on the computing device 200 as illustrated in FIG. 2 or the mobile device 300 as illustrated in FIG. 3. In some embodiments, one or more operations of process 500 may be implemented in the O2O service system 100 as illustrated in FIG. 1. In some embodiments, one or more operations in the process 500 may be stored in the storage device 150 and/or the storage (e.g., the ROM 230, the RAM 240, etc.) as a form of instructions, and invoked and/or executed by the server 110 (e.g., the processing device 112-A in the server 110, or the processor 220 of the processing device 112-A in the server 110). In some embodiments, the instructions may be transmitted in a form of electronic current or electrical signals.

In 510, the processing device 112-A (e.g., the acquisition module 401) may obtain real-time information related to a vehicle. In some embodiments, the vehicle may include a private car, an express car, a taxi, an electric vehicle, a motorcycle, a bus, a train, a hitch, a bullet train, a subway, a vessel, or the like, or any combination thereof. In some embodiments, the real-time information related to the vehicle may include an actual driving trajectory of the vehicle and a current location of the vehicle, which may be recorded or determined by a positioning device (e.g., the navigation system 160, a car recorder in the vehicle, a smartphone of a driver or passenger inside the vehicle). The actual driving trajectory may be displayed including one or more segments on a map application of the positioning device. The current location of the vehicle may be displayed as a point on a map application of the positioning device, and may be represented by a coordinate pair (e.g., a latitude-longitude coordinate) or by a description of the current location (e.g., the name of a street, the name of a building, the name of a bus station).

In some embodiments, the real-time information related to the vehicle may also include sound information inside the vehicle, video information inside the vehicle, profile information of a driver or a passenger inside the vehicle, or the like, or any combination thereof, which may be captured by a camera device. In some embodiments, the camera device may be a digital camera, a video camera, a security camera, a web camera, a smartphone, a tablet, a laptop, a camera with multiple lenses, a camcorder, etc. Merely by way of example, the sound information may be related to a driver sound, a passenger sound, other sounds inside the vehicle (e.g., a radio sound, a loud-speaker sound), or the like, or any combination thereof. The sound information may include a sound volume, sound contents (e.g., a conversation between the driver and the passenger), or the like. The video information may include one or more behaviors of the driver or the passenger (e.g., facial expression of the driver or the passenger, a motion behavior of the driver or the passenger), surroundings within the vehicle (e.g., whether there is an object inside the vehicle that may cause danger), or the like, or any combination thereof. In some embodiments, the facial expression may include a happy face, an angry face, a scared face, a surprised face, a depressed face, an excited face, a drunk face, a contemptuous face, an insensible face, or the like, or any combination thereof. For example, if the passenger threatens the driver, a scared face of the driver may be detected and recorded by the camera device. The motion behavior may include a threaten behavior, a violent behavior, a friendly behavior, or the like, or any combination thereof. For example, if the driver is a male driver and is grabbing the neck of the female passenger, the threaten behavior may be detected and recorded by the camera device. As another example, if the driver and the passenger have a fight, the violent behavior may be detected and recorded by the camera device. The profile information may include the gender of the driver or the passenger, a photo of the driver or the passenger, or the like, or any combination thereof.

In some embodiments, the real-time information may be collected in real time. Alternatively, the real-time information may be collected periodically (e.g., every minute). For example, the actual driving trajectory and/or the current location may be updated once every minute. In some embodiments, the real-time information may be collected when one or more conditions are met. For example, the real-time collection of the sound information and/or the video information may be triggered via the camera device inside the vehicle once a potential violence occurs. It should be noted that the above descriptions of the real-time information are merely for illustration purposes, and are not intended to limit the scope of the present disclosure. In some embodiments, the real-time information may include other contents, such as a driving behavior of the driver (e.g., an aggressive acceleration, an aggressive braking, an aggressive turn, or the like).

In some embodiments, the processing device 112-A may obtain the real-time information from one or more components of the O2O service system 100, such as a terminal (e.g., the requester terminal 130, the provider terminal 140), a storage device (e.g., the storage device 150), the navigation system 160, or the like, or any combination thereof. Alternatively or additionally, the processing device 112-A may obtain the real-time information from an external source (e.g., a car recorder) via the network 120.

In 520, the processing device 112-A (e.g., the determination module 403) may determine a probability of arising malicious event. In some embodiments, determining the probability of arising malicious event may be based on a degree of deviation between the actual driving trajectory and a predetermined driving trajectory, a desolate degree of the current location, a variation of the current location within a preset time length, at least one of a sound volume or one or more keywords from the sound information, at least one of one or more malicious behaviors or one or more malicious objects from the video information, whether the profile information of the driver or the passenger is consistent with a registered profile information of the driver or the passenger, whether the current time is within a preset time period, or the like, or any combination thereof.

In some embodiments, the processing device 112-A may determine the degree of deviation between the actual driving trajectory and the predetermined driving trajectory to generate a first result. The predetermined driving trajectory may be a driving trajectory automatically planned by the O2O service system 100 according to the departure location and the destination of the vehicle. In some embodiments, the processing device 112-A may determine the degree of deviation as the first result. In some embodiments, if a traffic accident or traffic control occurs on the predetermined driving trajectory, the vehicle may have to deviate from the predetermined driving trajectory. In this case, the traffic accident or the traffic control may be reported to the O2O service system 100 by the driver or the passenger via a terminal (e.g., the requester terminal 130, the provider terminal 140). When determining the degree of deviation, the processing device 112-A may not consider the deviation caused by the traffic accident or the traffic control.

In some embodiments, the processing device 112-A may determine the desolate degree of the current location to generate a second result. In some embodiments, the processing device 112-A may determine the desolate degree of the current location based on the latitude-longitude coordinate thereof. For example, a plurality of latitude-longitude coordinates and its corresponding desolate degrees may be stored in a storage device (e.g., the storage device 150). The processing device 112-A may retrieve the storage device 150 and determine the desolate degree of the current location. Alternatively, or additionally, the processing device 112-A may determine the desolate degree of the current location based on the surroundings of the current location and historical information related to the current location. The surroundings of the current location may include the density of buildings near the current location, the number of street lamps near the current location, the distance to the current location from the downtown, or the like, or any combination thereof. The historical information related to the current location may include the number of historical orders passing through the current location, historical traffic flow passing through the current location, or the like, or any combination thereof. In some embodiments, the smaller the density of buildings is, and/or the less the number of street lamps is, and/or the farther the distance is, and/or the less the number of historical orders is, and/or the smaller the historical traffic flow is, the greater the desolate degree of the current location is. Merely by way of example, the processing device 112-A may determine the number of historical orders passing through the current location, and determine the desolate degree of the current location based on the number of historical orders passing through the current location. In some embodiments, the processing device 112-A may determine the desolate degree of the current location as the second result.

In some embodiments, the processing device 112-A may determine the variation of the current location within the preset time length to generate a third result. The preset time length may be a default value or an empirical value related to the O2O service system 100. In some embodiments, the preset time length may be set according to a default setting of the O2O service system 100, or preset by a user. In some embodiments, the preset time length may be determined according to traffic conditions, the current location, the current time, or the like. For example, if the traffic is smooth, the current location is remote, and/or the current time is night, the preset time length may be short, such as 5 minutes. As another example, if the traffic is congested, the current location is bustling, and/or the current time is night, the preset time length may be long, such as 30 minutes. In some embodiments, the processing device 112-A may determine the preset time length by analyzing a plurality of historical orders passing through the current location using a machine learning algorithm (e.g., a neural network algorithm, a cluster analysis, a decision tree algorithm). In some embodiments, the processing device 112-A may compare the variation of the current location with a distance threshold to generate the third result. The distance threshold may be set according to a default setting of the O2O service system 100, or preset by a user. In some embodiments, the distance threshold may be a small area, such as a circular area with a radius of 2 meters. In some embodiments, the distance threshold may be a drift or an error of positioning data of the vehicle when the vehicle keeps still. In some embodiments, the third result may be a positive result (e.g., the variation of the current location being less than the distance threshold) or a negative result (e.g., the variation of the current location being not less than the distance threshold).

In some embodiments, the processing device 112-A may determine the sound volume and/or the one or more keywords from the sound information to generate a fourth result. In some embodiments, the keyword(s) may include word(s) used when a malicious event occurs. In some embodiments, the processing device 112-A may analyze sound information of a plurality of occurred malicious events to determine the one or more keywords that may be used under dangerous conditions. Merely by way of example, the keyword(s) may include but are not limited to “help,” “kill,” “robbery,” “please,” “money,” “put your hands up,” “not move,” or the like, or any combination thereof. In some embodiments, the processing device 112-A may determine whether one or more keywords exist and count the occurrence frequency of keywords using a speech recognition technique. Additionally, or alternatively, the processing device 112-A may determine whether the sound volume of the sound information exceeds a volume threshold. The volume threshold may be set according to a default setting of the O2O service system 100, or preset by a user. In some embodiments, the processing device 112-A may analyze multiple historical sound information using a machine learning algorithm to determine an average decibel (dB) of sound volume. The processing device 112-A may determine the average decibel (dB) of sound volume as the volume threshold. In some embodiments, the fourth result may be a positive result (e.g., the sound volume being greater than the volume threshold, having one or more keywords, the number of keywords), or a negative result (e.g., the sound volume being not greater than the volume threshold, not having one or more keywords).

In some embodiments, the processing device 112-A may determine the one or more malicious behaviors and/or the one or more malicious objects from the video information to generate a fifth result. In some embodiments, the malicious behavior(s) may refer to behavior(s) of the driver or the passenger when a malicious event occurs. Merely by way of example, the malicious behavior(s) may include but are not limited to binding, holding a knife, pulling, beating, threatening, or the like, or any combination thereof. The malicious object(s) may refer to object(s) used when a malicious event occurs. Merely by way of example, the malicious object(s) may include but are not limited to knife, stick, rope, sealing tape, or the like, or any combination thereof. In some embodiments, the processing device 112-A may determine the malicious behavior(s) and the malicious object(s) from the video information using an image recognition technique. In some embodiments, the fifth result may be a positive result (e.g., having malicious behavior(s), having malicious object(s), the number of malicious objects), or a negative result (e.g., not having malicious behavior(s), not having malicious object(s)).

In some embodiments, the processing device 112-A may determine whether the profile information of the driver or the passenger is consistent with the registered profile information of the drive or the passenger to generate a sixth result. In some embodiments, the registered profile information may include the gender of the driver or the passenger, the profile photo of the driver or the passenger, etc. In some embodiments, the processing device 112-A may determine whether the profile information is consistent with the registered profile information using an image processing technique (e.g., a face recognition technique) to generate the sixth result. In some embodiments, the sixth result may be a positive result (e.g., the profile information being consistent with the registered profile information) or a negative result (e.g., the profile information being not consistent with the registered profile information).

In some embodiments, the processing device 112-A may determine the probability of arising malicious event based on at least one of the first result, the second result, the third result, the fourth result, the fifth result, or the sixth result. Merely by way of example, the processing device 112-A may quantize the above one or more results to one or more corresponding specific values, and the processing device 112-A may determine the probability of arising malicious event based on the specific value(s).

Specifically, the processing device 112-A may determine the first result (or the degree of deviation) as a first value. The larger the degree of deviation is, the larger the first value is. The processing device 112-A may determine the second result (or the desolate degree) as a second value. The larger the desolate degree is, the larger the second value is. The processing device 112-A may determine a third value based on the third result. The third value may depend on whether the third result is the positive result (e.g., the variation of the current location being less than the distance threshold) or the negative result (e.g., the variation of the current location being not less than the distance threshold). If the third result is the positive result, the third value may be assigned with a relatively large value. Alternatively, if the third result is the negative result, the third value may be assigned with a relatively small value, such as 0. Similarly, the processing device 112-A may determine a fourth value based on the fourth result. If the fourth result is the positive result, the fourth value may be assigned with a relatively large value. The positive result may be that the sound volume is greater than the volume threshold, one or more keywords exist, or the like. In some embodiments, the number of keywords may also be considered. The larger the number of keywords is, the larger the fourth value is. If the fourth result is the negative result, the fourth value may be assigned with a relatively small value, such as 0. The negative result may be that the sound volume is not greater than the volume threshold, and one or more keywords do not exist. The processing device 112-A may determine a fifth value based on the fifth result. If the fifth result is the positive result, the fifth value may be assigned with a relatively large value. The positive result may be that malicious behavior(s) exist, malicious object(s) exist, or the like. In some embodiments, the number of malicious objects may be considered. The larger the number of malicious objects is, the larger the fifth value is. If the fifth result is the negative result, the fifth value may be assigned with a relatively small value, such as 0. The negative result may be that malicious behavior(s) do not exist and malicious object(s) do not exist. The processing device 112-A may determine a sixth value based on the sixth result. If the sixth result is the negative result (e.g., the profile information being not consistent with the registered profile information), the sixth value may be assigned with a relatively large value. If the sixth result is the positive result (e.g., the profile information being consistent with the registered profile information), the sixth value may be assigned with a relatively small value, such as 0.

In some embodiments, the processing device 112-A may determine whether the current time is within the preset time period to determine a seventh result. In some embodiments, the preset time period may be a default value or an empirical value related to the O2O service system 100. Alternatively, the preset time period may vary based on one or more conditions. In some embodiments, the processing device 112-A may determine the preset time period according to the sunset time, the sunrise time, and/or the current location of the vehicle. For example, the processing device 112-A may determine a time period between a time point after sunset (e.g., one hour after the sunset, two hours after the sunset) and a time point before sunrise (e.g., one hour before the sunrise, two hours before the sunrise) as the preset time period. As another example, if the current location of the vehicle is bustling, the processing device 112-A may determine the preset time period as 12:00 am-4:00 am. As a further example, if the current location of the vehicle is remote, the processing device 112-A may determine the preset time period as 10:00 pm-6:00 am. In some embodiments, the processing device 112-A may determine a seventh value based on the seventh result. The seventh value may depend on whether the seventh result is a positive result (e.g., the current time being within the preset time period) or a negative result (e.g., the current time being not within the preset time period). If the seventh result is a positive result, the seventh value may be assigned with a relatively large value. If the seventh result is a negative result, the seventh value may be assigned with a relatively small value, such as 0.

In some embodiments, the processing device 112-A may determine the probability of arising malicious event according to Equation (1) as below:

P=Σᵢ^{m}nᵢ*R₁, (1)

where P refers to the probability of arising malicious event; m refers to the number of values (or the number of results generated by the processing device 112-A); Rᵢ refers to the ith value corresponding to the ith result; nᵢ refers to the coefficient of the value Rᵢ. In certain embodiments, m may be equal to seven. R₁ may be the first value corresponding to the first result, R₂ may be the second value corresponding to the second result, R₃ may be the third value corresponding to the third result, R₄ may be the fourth value corresponding to the fourth result, R₅ may be the fifth value corresponding to the fifth result, R₆ may be the sixth value corresponding to the sixth result, and R₇ may be the seventh value corresponding to the seventh result.

In some embodiments, the coefficient nᵢ may be set according to a default setting of the O2O service system 100, or preset by a user. In some embodiments, the processing device 112-A may analyze a plurality of occurred malicious events using a machine learning algorithm to determine the coefficient of each value. It should be noted that the coefficient of each value may change. In some embodiments, the coefficient of a value corresponding to a result may be affected by other results. For example, when the desolate degree of the current location (i.e., the second result) is low, the coefficient n₃ of the third value corresponding to the third result may decrease. As another example, when the seventh result is the positive result (e.g., the current time being within the preset time period), it may indicate that the current time may be at night and the probability of arising malicious event may increase. Therefore, the coefficients of the values corresponding to the other six results may increase.

In some embodiments, the processing device 112-A may determine the probability of arising malicious event based on the real-time information and a trained probability determination model. In some embodiments, the trained probability determination model may be generated according to process 600. The processing device 112-A may input the real-time information into the trained probability determination model. The probability of arising malicious event may be outputted from the trained probability determination model.

In 530, the processing device 112-A (e.g., the determination module 403) may determine whether the probability of arising malicious event exceeds a probability threshold. The probability threshold may be a default value or an empirical value related to the O2O service system 100. In some embodiments, the probability threshold may be set according to a default setting of the O2O service system 100, or preset by a user. In some embodiments, the processing device 112-A may determine the probability threshold based on a plurality of occurred malicious events (also referred to as historical malicious events) according to a machine learning algorithm. The machine learning algorithm may include a neural network algorithm, a cluster analysis, a decision tree algorithm, or the like. Alternatively, or additionally, the processing device 112-A may determine the probability threshold based on a number or a percentage of historical orders that may arise malicious events. Merely by way of example, assuming that a total number of historical orders is 100,000 a day, the number of historical orders that may arise malicious events may be expected to be controlled within 1000, or the percentage of historical orders that may arise malicious events may be expected to be less than 1%. The processing device 112-A may rank the historical orders in a descending order based on the corresponding probabilities of arising malicious event, and determine the probability of the 1000th historical order as the threshold.

In response to a determination that the probability of arising malicious event does not exceed the probability threshold, the processing device 112-A may proceed to operation 510 and start a next round. Alternatively, or additionally, in response to a determination that the probability of arising malicious event exceeds the probability threshold, the processing device 112-A may determine that a potential malicious event exists and may proceed to operation 540. The potential malicious event may be or include a malicious event has occurred, or a malicious event that is very likely to occur.

In 540, the processing device 112-A (e.g., the intervention module 405) may perform one or more interventions. The intervention(s) may refer to measure(s) that can prevent the occurrence of a malicious event, or measure(s) that can reduce the loss (e.g., casualties, property damage) caused by an occurred malicious event. In some embodiments, the intervention(s) may include sending a prompt to a driver or a passenger inside the vehicle, sending a warning to the driver or the passenger inside the vehicle, calling the driver or the passenger inside the vehicle, sending help information to a person near the current location of the vehicle (e.g., a patrolman, a nearby driver), sending the help information to an executive institution (e.g., a police station), or the like, or any combination thereof. In some embodiments, the processing device 112-A may determine a corresponding intervention according to the probability of arising malicious event. For example, if the probability of arising malicious event is slightly greater than the probability threshold, the processing device 112-A may send a prompt or a warning to the driver or the passenger inside the vehicle. As another example, if the probability of arising malicious event is quite greater than the probability threshold, the processing device 112-A may send help information to an executive institution.

In some embodiments, after the processing device 112-A performs the intervention(s), the processing device 112-A may proceed to operation 510 and start a next round to determine whether the probability of arising malicious event at a next time interval still exceeds the probability threshold. In response to a determination that the probability of arising malicious event in the next time interval still exceeds the probability threshold, the processing device 112-A may continue to perform the intervention(s). Alternatively, in response to a determination that the probability of arising malicious event in the next time interval does not exceed the probability threshold, the processing device 112-A may stop performing the intervention(s).

In some embodiments of the present disclosure, the probability of arising malicious event may be determined according to the real-time information related to the vehicle. When the probability of arising malicious event exceeds the probability threshold, one or more interventions may be performed, which may decrease the number of occurred malicious events and reduce the loss caused by the occurred malicious events.

It should be noted that the above description regarding the process 500 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the processing device 112-A may obtain the real-time information with a certain obtaining frequency (e.g., 5 times an hour (times/h), 10 times/h, 30 times/h, 60 times/h, etc.). The obtaining frequency may be a default value or an empirical value related to the O2O service system 100. Alternatively, the obtaining frequency may be adjusted according to the probability of arising malicious events. For example, if the probability of arising malicious events exceeds the probability threshold, the processing device 112-A may increase the obtaining frequency (e.g., from 10 times/h to 20 times/h). If the probability of arising malicious events does not exceed the probability threshold, the processing device 112-A may decrease the obtaining frequency (e.g., from 10 times/h to 5 times/h).

In some embodiments, the processing device 112-A (e.g., the acquisition module 401) may obtain order information related to the vehicle. The order information may include order time, a departure location and a destination of the order, an order behavior of a passenger related to the vehicle, or the like, or any combination thereof. In some embodiments, the order behavior of the passenger may be reflected by order logs of the passenger. For example, the order behavior of the passenger may be that the passenger cancels an order and reorders within a short time. The processing device 112-A (e.g., the determination module 403) may determine the probability of arising malicious event based on the order information. In some embodiments, the processing device 112-A may determine a desolate degree of the departure location and/or the destination. If the departure location and/or the destination have relatively large desolate degree, the probability of arising malicious event may be large. As another example, the processing device 112-A may determine whether the passenger cancels an order and reorders within a short time. If the processing device 112-A determines that the passenger cancels an order and reorders within a short time, the probability of arising malicious event may be large. In some embodiments, the processing device 112-A may determine the probability of arising malicious event based on the order information and the real-time information.

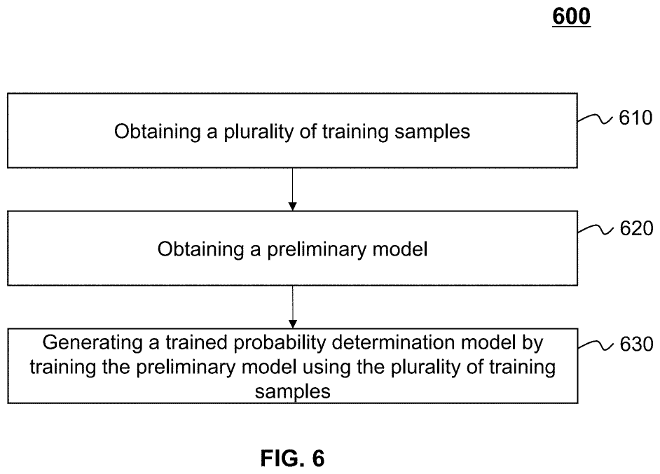

FIG. 6 is a flowchart illustrating an exemplary process for determining a trained probability determination model according to some embodiments of the present disclosure. For illustration purposes only, the processing device 112-B may be described as a subject to perform the process 600. However, one of ordinary skill in the art would understand that the process 600 may also be performed by other entities. For example, one of ordinary skill in the art would understand that at least a portion of process 600 may be implemented on the computing device 200 as illustrated in FIG. 2 or the mobile device 300 as illustrated in FIG. 3. In some embodiments, one or more operations of process 600 may be implemented in the O2O service system 100 as illustrated in FIG. 1. In some embodiments, one or more operations in the process 600 may be stored in the storage device 150 and/or the storage (e.g., the ROM 230, the RAM 240, etc.) as a form of instructions, and invoked and/or executed by the server 110 (e.g., the processing device 112-B in the server 110, or the processor 220 of the processing device 112-B in the server 110). In some embodiments, the instructions may be transmitted in a form of electronic current or electrical signals.

In 610, the processing device 112-B (e.g., the obtaining module 451) may obtain a plurality of training samples. The plurality of training samples may include a plurality of occurred malicious events (also referred to as historical malicious events), and the real-time information corresponding to each of the plurality of occurred malicious events. In some embodiments, the plurality of occurred malicious events may correspond to one type of vehicle. For example, the plurality of occurred malicious events may correspond to taxi. Alternatively, the plurality of occurred malicious events may correspond to two or more types of vehicle. For example, a first portion of the occurred malicious events may correspond to taxi, and a second portion of the occurred malicious events may correspond to bus. In some embodiments, the real-time information may refer to real-time information related to a vehicle when a malicious event occurs. The real-time information may include an actual driving trajectory of the vehicle, a current location of the vehicle, sound information inside the vehicle, video information inside the vehicle, profile information of a driver or a passenger inside the vehicle, or the like, or any combinations thereof. More descriptions regarding the real-time information may be found elsewhere in the present disclosure (e.g., operation 510 of the process 500, and the relevant descriptions thereof).

In some embodiments, the processing device 112-B may obtain the plurality of training samples from one or more components of the O2O service system 100, for example, the server 110, a terminal (e.g., the requester terminal 130, the provider terminal 140), a storage device (e.g., the storage device 150). Alternatively, or additionally, the processing device 112-B may obtain the plurality of training samples from an external source (e.g., a car recorder) via the network 120.

In 620, the processing device 112-B (e.g., the obtaining module 451) may obtain a preliminary model. In some embodiments, the preliminary model may include a plurality of preliminary weights (or parameters). The preliminary weights (or parameters) may be adjusted and/or updated during the training process of the preliminary model.

In some embodiments, the preliminary model may include a Ranking Support Vector Machine (SVM) model, a Gradient Boosting Decision Tree (GBDT) model, a LambdaMART model, an adaptive boosting model, a recurrent neural network model, a convolutional network model, a hidden Markov model, a perceptron neural network model, a Hopfield network model, a self-organizing map (SOM), or a learning vector quantization (LVQ), or the like, or any combination thereof. The recurrent neural network model may include a long short term memory (LSTM) neural network model, a hierarchical recurrent neural network model, a bi-direction recurrent neural network model, a second-order recurrent neural network model, a fully recurrent network model, an echo state network model, a multiple timescales recurrent neural network (MTRNN) model, etc.

In some embodiments, the processing device 112-B may obtain the preliminary model from one or more components of the O2O service system 100, for example, the server 110, a terminal (e.g., the requester terminal 130, the provider terminal 140), a storage device (e.g., the storage device 150). Alternatively, or additionally, the processing device 112-B may obtain the preliminary tagging model from an external source via the network 120.

In 630, the processing device 112-B (e.g., the training module 453) may generate a trained probability determination model by training the preliminary model using the plurality of training samples.

In some embodiments, the real-time information corresponding to an occurred malicious event may be inputted into the preliminary model to determine an actual output. The actual output may be a first value representing a malicious event, or a second value representing a not malicious event. For the real-time information corresponding to the plurality of occurred malicious events, a plurality of actual outputs may be determined. A desired output may be the first value representing a malicious event. The processing device 112-B may compare each of the plurality of actual outputs with the desired output to determine a loss function. The loss function may measure a difference between the actual output(s) and the desired output. During the training of the preliminary model, the processing device 112-B may adjust the plurality of preliminary weights (or parameters) to minimize the loss function. In some embodiments, the loss function and the preliminary weights (or parameters) may be updated iteratively in order to obtain a minimized loss function. The iteration to minimize the loss function may be repeated until a termination condition is satisfied. An exemplary termination condition is that an updated loss function with the updated weights (or parameters) obtained in an iteration is less than a predetermined threshold. The predetermined threshold may be set manually or determined based on various factors including, such as the accuracy of the trained tagging model, etc.

After the loss function is minimized, a trained probability determination model may be determined according to the adjusted weights (or parameters). In some embodiments, the adjusted weights (or parameters) may be the coefficients of the values corresponding to the result. In some embodiments, when the real-time information is inputted in the trained probability determination model, a probability of arising malicious event may be outputted from the trained probability determination model. In some embodiments, the trained probability determination model may be stored in a storage device in the O2O service system 100, such as the storage device 150, the ROM 230, the RAM 240, or the like.

It should be noted that the above description regarding the process 600 is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for determining a potential malicious event in a vehicle, comprising:
at least one storage device including a set of instructions;
at least one processor in communication with the at least one storage device; and
a communication platform connected to a network, wherein when executing the set of instructions, the at least one processor is configured to cause the system to:
obtain real-time information related to a vehicle;
determine, based on the real-time information of the vehicle, a probability of arising malicious event;
determine whether the probability of arising malicious event exceeds a probability threshold;
in response to a determination that the probability of arising malicious event exceeds the probability threshold, determine that a potential malicious event exists.

2. The system of claim 1, wherein the real-time information related to the vehicle includes at least one of an actual driving trajectory of the vehicle, a current location of the vehicle, sound information inside the vehicle, video information inside the vehicle, or profile information of a driver or a passenger inside the vehicle.

3. The system of claim 2, wherein determining the probability of arising malicious event is based on at least one of:
a degree of deviation of the actual driving trajectory from a predetermined driving trajectory;
a desolate degree of the current location;
a variation of the current location within a preset time length;
at least one of a sound volume or one or more keywords from the sound information;
at least one of one or more malicious behaviors or one or more malicious objects from the video information; or
whether the profile information of the driver or the passenger is consistent with a registered profile information of the driver or the passenger.

4. The system of claim 1, wherein the real-time information related to the vehicle includes a current time, and determining the probability of arising malicious events is further based on:
whether the current time is within a preset time period.

5. The system of claim 1, wherein the at least one processor is further configured to cause the system to:
obtain order information related to the vehicle, the order information including order time, a departure location and a destination of the order, an order behavior of the passenger related to the vehicle; and
determine the probability of arising malicious event based on the order information and the real-time information.

6. The system of claim 1, wherein to determine the probability of arising malicious event, the at least one processor is further configured to cause the system to:
obtain a trained probability determination model; and
determine the probability of arising malicious event based on the real-time information and the trained probability determination model.

7. The system of claim 6, wherein the trained probability determination model is generated by training a preliminary model based on one or more historical malicious events.

8. The system of claim 1, wherein the at least one processor is further configured to cause the system to:
in response to a determination that the probability of arising malicious event exceeds the probability threshold, perform one or more interventions.

9. The system of claim 8, wherein the one or more interventions include at least one of:
sending a prompt to the driver or the passenger inside the vehicle;
sending a warning to the driver or the passenger inside the vehicle;
calling the driver or the passenger inside the vehicle;
sending help information to a person near the current location of the vehicle; or
sending the help information to an executive institution.

10. A method for determining a potential malicious event in a vehicle, implemented on a computing device having at least one processor, at least one computer-readable storage medium, and a communication platform connected to a network, comprising:
obtaining real-time information related to a vehicle;
determining, based on the real-time information of the vehicle, a probability of arising malicious event;
determining whether the probability of arising malicious event exceeds a probability threshold;
in response to a determination that the probability of arising malicious event exceeds the probability threshold, determining that a potential malicious event exists.

11. The method of claim 10, wherein the real-time information related to the vehicle includes at least one of an actual driving trajectory of the vehicle, a current location of the vehicle, sound information inside the vehicle, video information inside the vehicle, or profile information of a driver or a passenger inside the vehicle.

12. The method of claim 11, wherein determining the probability of arising malicious events is based on at least one of:
a degree of deviation of the actual driving trajectory from a predetermined driving trajectory;
a desolate degree of the current location;
a variation of the current location within a preset time length;
at least one of a sound volume or one or more keywords from the sound information;
at least one of one or more malicious behaviors or one or more malicious objects from the video information; or
whether the profile information of the driver or the passenger is consistent with a registered profile information of the driver or the passenger.

13. The method of claim 10, wherein the real-time information related to the vehicle includes a current time, and determining the probability of arising malicious events is further based on:
whether the current time is within a preset time period.

14. The method of claim 10, wherein the at least one processor is further configured to cause the system to:
obtain order information related to the vehicle, the order information including order time, a departure location and a destination of the order, an order behavior of the passenger related to the vehicle; and
determine the probability of arising malicious event based on the order information and the real-time information.

15. The method of claim 10, wherein to determine the probability of arising malicious event, the at least one processor is further configured to cause the system to:
obtain a trained probability determination model; and
determine the probability of arising malicious event based on the real-time information and the trained probability determination model.

16. The method of claim 15, wherein the trained probability determination model is generated by training a preliminary model based on one or more historical malicious events.

17. The method of claim 10, wherein the at least one processor is further configured to cause the system to:
in response to a determination that the probability of arising malicious event exceeds the probability threshold, perform one or more interventions.

18. The method of claim 17 wherein the one or more interventions include at least one of:
sending a prompt to the driver or the passenger in the vehicle;
sending a warning to the driver or the passenger in the vehicle;
calling the driver or the passenger in the vehicle;
sending help information to a person near the current location of the vehicle; or
sending the help information to an executive institution.

19. A non-transitory computer-readable storage medium, comprising at least one set of instructions for determining a potential malicious event in a vehicle, wherein when executed by at least one processor of a computing device, the at least one set of instructions directs the at least one processor to perform acts of:
obtaining real-time information related to a vehicle;
determining, based on the real-time information of the vehicle, a probability of arising malicious event;
determining whether the probability of arising malicious event exceeds a probability threshold;
in response to a determination that the probability of arising malicious event exceeds the probability threshold, determining that a potential malicious event exists.

20. The non-transitory computer-readable storage medium of claim 19, wherein determining a probability of arising malicious events is based on at least one of:
a degree of deviation between the actual driving trajectory and a predetermined driving trajectory;
a desolate degree of the current location;
a variation of the current location within a preset time
at least one of a sound volume or one or more words from the sound information;
at least one of one or more malicious behaviors or one or more malicious objects from the video information; or
whether the profile information of the driver or the passenger is consistent with a registered profile information of the driver or the passenger.

21-22. (canceled)
